(19) United States
(12) Patent Application Publication
(10) Pub. No.: US 2026/0281692 A1
(43) Pub. Date: Sep. 17, 2026

(54) SEAMLESS ROAMING PREPARATION WITH MULTIPLE TARGET ACCESS POINT MULTI-LINK DEVICES

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/549,984

(22) Filed: Feb. 25, 2026

Related U.S. Application Data
(60) Provisional application No. 63/955,890, filed on Jan. 7, 2026.
(60) Provisional application No. 63/763,089, filed on Feb. 25, 2025.

(51) Int. Cl. H04W 8/14; H04W 76/15

(52) U.S. Cl. CPC H04W 8/14; H04W 76/15

(57) ABSTRACT

Seamless roaming preparation for a STA to multiple target AP MLDs. An AP MLD that the STA is connected to can receive multiple roaming preparation requests from the STA for different target AP MLDs. The AP MLD transmits the roaming preparation requests to the different target AP MLDs and receives a response from the different target AP MLDs indicating whether each of the different target AP MLDs accepted the roaming preparation request. The AP MLD transmits the responses back to the STA along with roaming information for at least one target AP MLD.

### CROSS-REFERENCE TO RELATED APPLICATIONS

This application claims benefit of co-pending United States provisional patent application Serial No. 63/763,089 filed Feb. 25, 2025, and co-pending United States provisional patent application Serial No. 63/955,890 filed Jan. 7, 2026. The aforementioned related patent applications are herein incorporated by reference in their entirety.

### TECHNICAL FIELD

Embodiments presented in this disclosure generally relate to seamless roaming to an access point (AP). More specifically, embodiments disclosed herein relate to preparing multiple APs for seamless roaming prior to a station (STA) performing roaming transition.

### BACKGROUND

A Seamless Mobility Domain (SMD) consists of multiple AP multi-link devices (MLDs) between which a client (a non-AP MLD or STA) can perform seamless roaming procedure. A client can access a network by associating with an SMD management entity (SMD-ME) within an SMD and the client can perform seamless roaming (also referred to as SMD roaming or SMD BSS transition (ST)) between multiple AP MLDs that are part of the SMD. As the client moves, the client can perform seamless roaming to connect to another AP MLD in the same SMD to maintain connection with the network. Seamless roaming procedure involves two phases – roaming preparation and roaming execution. As part of the roaming preparation procedure, the non-AP MLD can prepare a target AP MLD in advance by setting up or adding links at the target AP MLD, by transferring non-AP MLD context, or by reserving resources at the target AP MLD for the non-AP MLD. After roaming preparation, the non-AP MLD can then perform roaming execution to the target AP MLD to complete its roaming transition. In many cases, based on the mobility pattern and channel conditions at the non-AP MLD, there can be multiple possible candidate target AP MLDs where a non-AP MLD can roam to for continuing its connectivity. If a non-AP MLD can only prepare a single target AP MLD for roaming and, based on conditions at the client, the single prepared target AP MLD is no longer a good candidate for roaming, then the roaming preparation does not get used and the non-AP MLD would prepare another target AP MLD, adding to roaming delays. Hence, it is beneficial to allow a non-AP MLD to prepare multiple target AP MLDs for roaming allowing for the non-AP MLD to roam to the most preferred candidate target AP MLD among the prepared set of target AP MLDs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts a diagram of an AP preparing for a STA to roam based on multiple roaming requests, according to one embodiment.

FIG. 1B and 1C depict a diagram of a STA roaming to a target AP, according to one embodiment.

FIG. 1D depicts a diagram of an AP preparing for a STA to roam based on a roaming request, according to one embodiment.

FIG. 2 depicts a flowchart of an exemplary method for an AP preparing for a STA to roam based on multiple roaming requests, according to one embodiment.

FIG. 3 depicts a flowchart of an exemplary method for an AP preparing for a STA to roam based on a roaming request, according to one embodiment.

FIG. 4 depicts an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP MLD that includes one or more memories; and one or more processors communicatively coupled to the one or more memories. The one or more processors are configured to, individually or collectively, perform operations including receiving a roaming preparation request from a station (STA). The operations further include transmitting, based on the roaming preparation request, a second request to multiple of target AP MLDs. The operations further include receiving multiple responses to the second request from the multiple target AP MLDs where each of the multiple responses indicates whether a respective target AP MLD in the multiple target AP MLDs accepts the second request and transmitting, based on the multiple responses, a roaming preparation response to the STA, where the roaming preparation response includes information for the STA to roam to at least one of the multiple target AP MLDs. Additional embodiments may include a method. One embodiment presented in this disclosure is an AP MLD that includes one or more memories; and one or more processors communicatively coupled to the one or more memories. The one or more processors are configured to, individually or collectively, perform operations including receiving multiple roaming preparation request frames from a STA where each of the multiple roaming preparation request frames designates a different target AP MLD in multiple target AP MLDs for roaming. The operations further include transmitting, based on the multiple roaming preparation request frames, a second request to the multiple target AP MLDs. The operations further include receiving multiple responses to the second request from the multiple target AP MLDs, wherein each of the multiple responses indicates whether a respective target AP MLD in the multiple target AP MLDs accepts the second request and transmitting, based on the multiple responses, multiple roaming preparation response frames to the STA, wherein the multiple roaming preparation response frames includes information for the STA to roam to at least one of the multiple target AP MLDs, and where the number of the multiple roaming preparation response frames matches the number of the multiple roaming preparation request frames.

### Example Embodiments

The present disclosure describes preparing multiple target AP MLDs to which a client may roam as part of a seamless roaming preparation procedure. A client (non-AP MLD or STA) can associate with an SMD-ME within an SMD that consists of multiple AP MLDs, through one of the AP MLDs (which may also be referred to as a serving AP MLD or a current AP MLD) in the SMD. As the client moves, the client may disconnect from the serving AP MLD, causing an interruption of the client accessing the network. For use cases such as industrial Internet of Things (IIoT) use cases, such as with autonomous guided vehicles (AGVs) or autonomous mobile robots (AMRs) mobile clients, automotive use cases with mobile vehicles, and other use cases involving mobile clients (such as smartphones, tablets, laptops etc.), the client can benefit from preparing multiple target AP MLDs in advance for roaming preparation and then roaming to one of those target AP MLDs based on how the client moves.

In some instances, AP MLDs within an SMD can transmit beacon, probe response, or (re)association response frames indicating that the AP MLDs can prepare multiple target AP MLDs for seamless roaming and indicate a maximum number of target AP MLDs that can be prepared for seamless roaming. The associated client may transmit a roaming preparation request to prepare a target AP MLD through its serving AP MLD. The number of target AP MLDs that can be prepared may be limited to the maximum number of target AP MLDs indicated in the beacon transmitted from the serving AP MLD and other AP MLDs in the SMD (e.g., in an SMD Information element). The roaming preparation for a target AP MLD is initiated by the client (or non-AP MLD). In some instances, the client performs roaming preparation separately for each candidate target AP MLD through its serving AP MLD by transmitting a separate roaming preparation request (e.g., a UHR link reconfiguration request) to its serving AP MLD for each target AP MLD. The serving AP MLD may accept multiple roaming preparation requests from a client for different target AP MLDs (or the same target AP MLD). After receiving the roaming preparation requests, the serving AP MLD then transmits the request for roaming preparation to each of the target AP MLDs and receives a response for each request for roaming preparation from the target AP MLDs. The serving AP MLD transmits the responses back to the client indicating the outcome of roaming preparation at the target AP MLDs with each of the responses indicating whether roaming preparation was accepted or rejected at the target AP MLDs. The separate roaming preparation request and response exchanges for preparing multiple target AP MLDs may be done in sequence or in parallel. For example, the client may transmit a roaming preparation request for a first target AP MLD to the serving AP MLD, waits for a roaming preparation response frame from the serving AP MLD and then transmits another roaming preparation request for a second target AP MLD, i.e., performing roaming preparation to multiple target AP MLDs in sequence. In some embodiments, the client may transmit multiple roaming preparation requests for preparing multiple target AP MLDs at the same time, i.e., transmit these requests in parallel. The serving AP MLD requests for roaming preparation at the target AP MLDs as it receives the roaming preparation requests from the client regardless if the roaming preparation requests are sent in sequence or in parallel. After receiving responses for the roaming preparation, such as acceptance or rejection, from the target AP MLDs, the serving AP MLD transmits the roaming preparation response frames to the client.

In some instances, the roaming preparation requests from the client include an identifier indicating that each of the roaming preparation requests are part of the same roaming process or roaming sequence. In some instances, the serving AP MLD maintains the roaming preparation information (e.g., the list of target AP MLDs that have been prepared for the client) until the client roams away from the serving AP MLD.

In embodiments described, the roaming preparation request from the client to the serving AP MLD may be a UHR link reconfiguration request and the roaming preparation response frame from the serving AP MLD to the client may be a UHR link reconfiguration response. The request sent from the serving AP MLD to a target AP MLD for roaming preparation may be different than the roaming preparation request received from the client and the response from the target AP MLD to the serving AP MLD for roaming preparation may be different than the roaming preparation response frame sent to the client. For example, these may carry different set of information or formatted differently.

In some instances, the client can update the roaming preparation request for one of the target AP MLDs by sending another roaming preparation request to the serving AP MLD with revised set of parameters for roaming preparation. For example, the client may update a set of links added at the target AP MLD for the client or update a client’s context information at the target AP MLD (e.g. update Stream Classification Service (SCS), Block Acknowledge (BA) contexts, Mirrored Stream Classification Service (MSCS) context, and any other context information when these get updated with the serving AP MLD) or (re)negotiate client’s context with the target AP MLD (e.g. SCS agreements or block acknowledgement agreements). In some embodiments, the client may want to update its roaming preparation with an already prepared target AP MLD if the client’s context changes with its serving AP MLD, e.g., a client establishes new SCS streams, updates its BA agreements with the serving AP MLD, update a MSCS context for the client, or updating any other context information with the serving AP MLD. Then the client may want to provide an updated set of context to the already prepared target AP MLD. The client may perform this by sending another roaming preparation request to the serving AP MLD for the same target AP MLD with revised set of roaming preparation parameters. The serving AP MLD may transmit the updated roaming preparation request to the target AP MLD, receive a response from the target AP MLD, and transmit a roaming preparation response frame to the client indicating the outcome of roaming preparation update at the target AP MLD. The serving AP MLD may update the existing roaming preparation information that is maintained on the serving AP MLD for the client based on the roaming preparation updates for the target AP MLD.

In some instances, the updated roaming preparation request (i.e. the UHR link reconfiguration request) may include an indication that the roaming preparation request is for updating the roaming preparation for an already prepared target AP MLD (e.g. an “Update roaming preparation” indication) instead of a roaming preparation request for adding roaming preparation for a new target AP MLD. In some instances, the roaming preparation request includes an indication that the roaming preparation request is for adding roaming preparation to a new target AP MLD. This “Update roaming preparation” indication for roaming preparation may be signaled using a new Type value defined for the UHR link reconfiguration request used for roaming preparation request, e.g., a Type value indicating ‘Update roaming preparation’ (or “Update ST preparation”). The UHR link reconfiguration request with this new Type value may include the updated set of parameters for roaming preparation for the target AP MLD. The serving AP MLD may signal to the target AP MLD to update the previous roaming preparation for the non-AP MLD based on the updated set of parameters indicated for roaming preparation, receive a response from the target AP MLD for updating the roaming preparation, and provide the response to the client in a UHR link reconfiguration response which uses the same new Type value (as in the corresponding request) indicating “Update roaming preparation.”

When updating roaming preparation for an already prepared target AP MLD, the updates requested for roaming preparation may be accepted by the target AP MLD or may get rejected by the target AP MLD. If the updates for roaming preparation are accepted by the target AP MLD, then the previous roaming preparation at the target AP MLD is no longer valid or applicable and has been replaced with the updated roaming preparation. If the updates for roaming preparation are not accepted by the target AP MLD, then the target AP MLD may keep the previous roaming preparation for the client, or the target AP MLD does not keep the previous roaming preparation for the client and hence it does not have any roaming preparation for the client (since updated roaming preparation was not accepted). If a separate “Update roaming preparation” type is defined, then the target AP MLD may keep the previous roaming preparation for the client. In some embodiments, the target AP MLD may not keep the previous roaming preparation if the update to the roaming preparation fails (or is rejected).

In some embodiments, the serving AP MLD (or AP MLDs in the SMD) does not allow for a client to update a previous roaming preparation. In such instances, the serving AP MLD may reject a roaming preparation request that is requesting to prepare (or update roaming preparation) for an already prepared target AP MLD.

In some instances, the client sends a roaming preparation request (e.g., a UHR link reconfiguration request) that indicates multiple target AP MLDs to prepare for roaming. In this case, instead of the client sending separate roaming preparation requests for each target AP MLD, the client sends one roaming preparation request that indicates request for roaming preparation for multiple target AP MLDs. The serving AP MLD can transmit a request to each of the multiple target AP MLDs indicated in the roaming preparation request and receive a response from each of the multiple target AP MLDs. In some instances, the serving AP MLD combines each of the responses from the multiple targe AP MLDs into one roaming preparation response frame. The serving AP MLD transmits the roaming preparation response frame to the client along with a status of whether each of the multiple target AP MLDs accepted or rejected the roaming preparation request and provides roaming preparation related information for target AP MLDs (e.g. the set of links added for the client at the target AP MLD, resources reserved and context transferred). Additionally, or alternatively, the serving AP MLD may transmit a separate roaming preparation response frame for each target AP MLD indicating whether the target AP MLD accepted or rejected the roaming preparation and, if the target AP MLD accepted, roaming preparation related information for the target AP MLD.

In some instances, the client sends a roaming preparation request with multiple target AP MLDs to be prepared, and the request indicates a preference order for multiple target AP MLDs to prepare for roaming. For example, the roaming preparation request may include an identifier (e.g., a target AP MLD MAC address) for each of the multiple target AP MLDs and the roaming preparation request may include the identifiers in order from highest preference to lowest preference, or vice versa. As another example, the roaming preparation request may include a preference field indicating relative preference for target AP MLDs among the multiple target AP MLDs that are included in the request. In some instances, the serving AP MLD considers preferences from the client and a policy on the serving AP MLD for deciding which target AP MLDs to prepare for roaming. For example, the serving AP MLD may have a policy that limits preparing a target AP MLD for roaming that meets or exceeds a threshold number of associated clients. In this example, the serving AP MLD may not prepare a given target AP MLD for roaming based on this policy and prepare other requested target AP MLDs for roaming.

In the roaming preparation request requesting preparation for multiple target AP MLDs, a client can apply inheritance across information indicated for each target AP MLD. In this case, the client may include parameters and elements for a given non-AP STA for roaming preparation only once for one of the target AP MLD and inherit that information for the other target AP MLDs in the request. For example, this can be achieved by applying inheritance (similar to the inheritance defined for 802.11be) across multiple reconfiguration multi-link (ML) elements included for multiple target AP MLDs in the request.

In some embodiments, the systems provide several technical advantages. For example, by preparing multiple target AP MLDs for a roaming client, the client is more likely to quickly transition from a serving AP MLD on a network to a target AP MLD as the client moves. This allows the client to remain attached to the network with minimal disruptions. Furthermore, by preparing multiple target AP MLDs for roaming, the serving AP MLD uses less processing power on predicting which of multiple target AP MLDs to which the client should be prepared to roam. Additionally, by allowing update to the roaming preparation for an already prepared target AP MLD, the roaming preparation can be modified based on any changes between the client and the serving AP MLD, allowing roaming preparations to be based on the latest client context at the serving AP MLD. Additionally, by using inheritance for determining information for the roaming to the multiple target AP MLDs, the roaming preparation request(s) may be optimized to include less information.

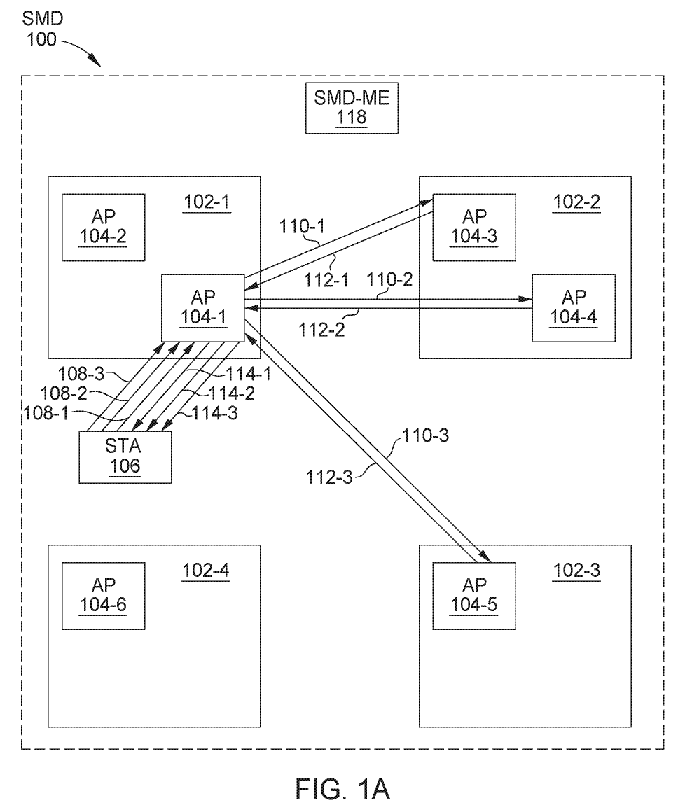

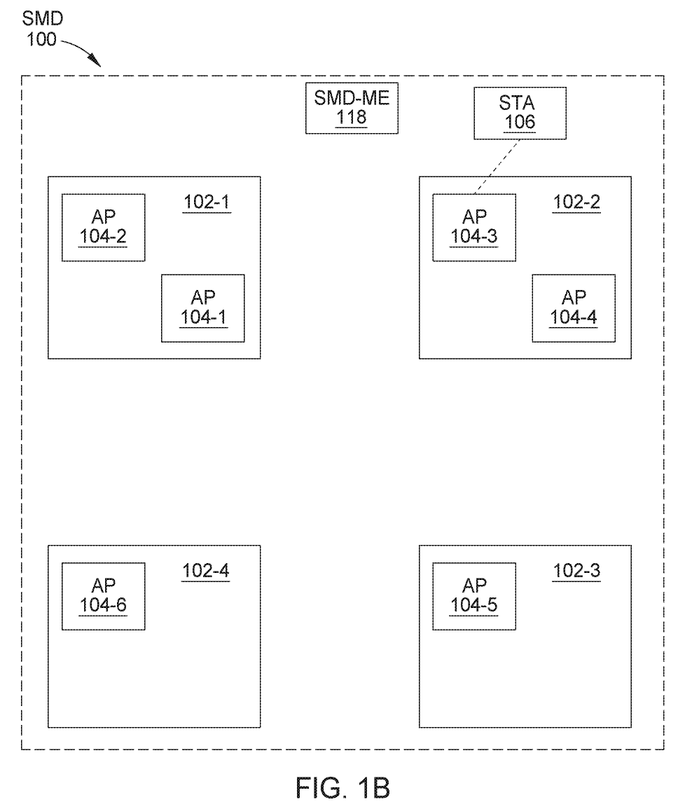

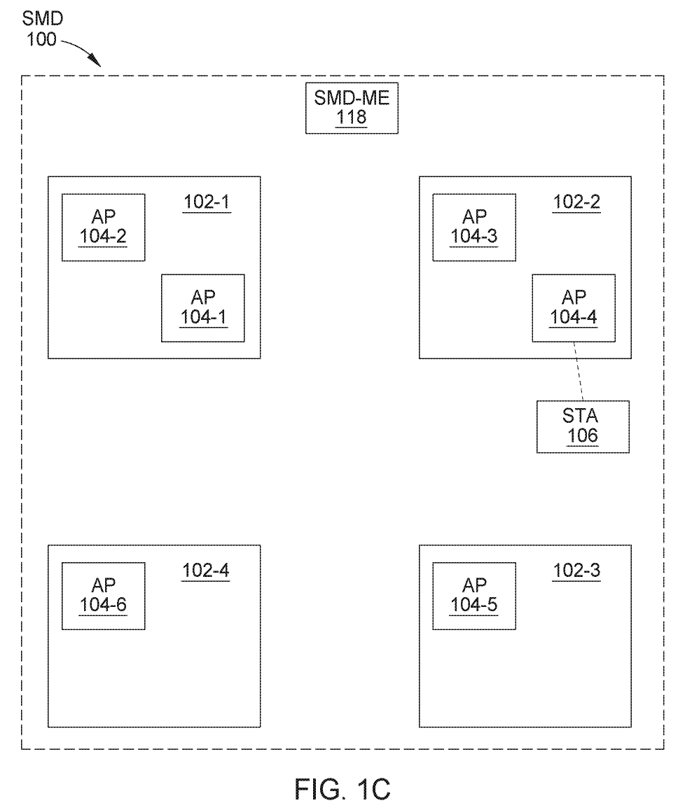

FIG. 1A depicts an SMD 100 that includes AP MLDs 104-1 through 104-6 to access a network. The AP MLDs 104-1 through 104-6 are part of the same SMD 100. Each of the AP MLDs 104-1 through 104-6 are deployed in different locations 102-1 through 102-4 in a given deployment (such as in a warehouse or an office building or an urban downtown area). A STA 106 (such as an AGV, AMR, a vehicle, a smartphone, a laptop, or a tablet) may be associated with an SMD-ME 118 in the SMD 100 and connected with one of the AP MLDs 104-1 through 104-6 to connect to the network. The STA 106 may connect with different AP MLDs based on geographical location of the STA 106 in relation to each of the AP MLDs 104-1 through 104-6. In an exemplary embodiment, the STA 106 is connected with the AP 104-1 because the AP MLD 104-1 is close to the STA 106, making the AP MLD 104-1 a serving AP MLD for the STA 106. In one embodiment, a beacon transmitted from the AP MLD 104-1 includes information indicating that the AP MLD 104-1 can prepare multiple target AP MLDs for roaming and indicating a maximum number of target AP MLDs that can be prepared for roaming.

As the STA 106 moves, the connection between the STA 106 and the serving AP MLD 104-1 may weaken. So, the STA 106 may decide to roam to one of the AP MLDs 104-2 through 104-6 to maintain a connection with the network. If the STA 106 knows that the serving AP MLD 104-1 can prepare target AP MLDs for roaming, such as through a beacon or a probe response, the STA 106 transmits roaming preparation request frames 108-1 through 108-3 (e.g. UHR link reconfiguration request frames) to the serving AP MLD 104-1 to start roaming preparation for multiple target AP MLDs. In one embodiment, the number of roaming preparation request frames transmitted from the STA 106 is based on the maximum number of target AP MLDs allowed for preparation as indicated in a beacon or a probe response from the serving AP MLD 104-1. For example, if the AP MLD 104-1 indicates to the STA 106 that the maximum number of target AP MLDs allowed for roaming preparation is three, such as through a beacon, a probe response or a (re)association response, then the STA 106 may transmit a number of roaming preparation request frames that is three or less. Each of the roaming preparation request frames 108-1 through 108-3 are directed towards a different one of the AP MLDs 104-2 through 104-6. In an exemplary embodiment, the roaming preparation request frame 108-1 is for preparing to roam to the AP MLD 104-3, the roaming preparation request frame 108-2 is for preparing to roam to the AP MLD 104-4, and the roaming preparation request frame 108-3 is for preparing to roam to the AP MLD 104-5, making the AP MLDs 104-3 through 104-5 target AP MLDs for the roaming preparation for the STA 106. Each of the roaming preparation requests frames 108-1 through 108-3 may include elements or fields (such as reconfiguration ML elements indicating links to be added, block acknowledge agreements, or SCS agreements information) for preparing the respective target AP MLDs 104-3 through 104-5 for roaming.

In one embodiment, the roaming preparation request frame 108-1 includes information for roaming preparation for one target AP MLD such as links to be added at the target AP MLD, client context information (e.g., for SCS, Block acknowledge, etc.), and request for resource reservation at the target AP MLD. Each of the roaming preparation request frames 108-1 through 108-3 may include a preference for the STA 106 indicating a preference to roam to one of the target AP MLDs 104-3 through 104-5 that is indicated in the roaming preparation request frames 108-1 through 108-3. The preference may be indicated in the roaming preparation request frames 108-1 through 108-3 as an identifier, such as, but not limited to, a number, letter, or a combination thereof. The preference field can be used as an input at the serving AP MLD or the target AP MLD to decide which target AP MLDs to prepare. For example, if the STA 106 provides a high preference value for the target AP MLD 104-3 in the roaming preparation request, then the target AP MLD 104-3 (and/or the serving AP MLD 104-1) can consider that in preparing the target AP MLD 104-3.

In some embodiments, the STA 106 may prefer to prepare a target AP MLD only if all requested links are accepted by the target AP MLD. The STA 106 can indicate a preference in a field of the roaming preparation request frames 108-1 through 108-3 to prepare the target AP MLD only if the target AP MLD can accept all requested links. For example, the field may be a 1-bit field that indicates “Prepare Only If All Requested Links Accepted.” If such an indication is provided in the roaming preparation request frames 108-1 through 108-3 from the STA 106 and one of the target AP MLDs 104-3 through 104-5 cannot accept all the requested links, then that target AP MLD is not prepared, and roaming preparation fails for that target AP MLD. An appropriate response (or status code) may be provided in roaming preparation response frames 114-1 through 114-3 to indicate the reason for roaming preparation failure (e.g., a status code). The preparation request frames 108-1 through 108-3 may include one or more of the following criteria for preparing a target AP MLD: to prepare a target AP MLD only if at least a minimum number of links are accepted by the target AP MLD (e.g., if requesting four links, then indicate to only prepare if at least 3 links are accepted); to prepare a target AP MLD only if a specific set of the requested links are accepted by the target AP MLD (e.g. if the STA 106 is requesting three links on 2.4 GHz, 5 GHz, and 6 GHz, then the STA 106 can indicate to only prepare if at least the 5 GHz and 6 GHz links are accepted); to prepare a target AP MLD only if at least a minimum number of SCS streams are accepted by the target AP MLD (e.g. if five SCS streams are set up, then the STA 106 may indicate to only prepare, if at least three SCS streams are accepted); to prepare a target AP MLD only if specific SCS streams or types of SCS streams (e.g. SCS streams with high priority traffic identifiers (TIDs)) are accepted by the target AP MLD (e.g. prepare only if SCS streams with TID 4, 5, 6, 7 are accepted or SCS streams with TIDs 6, 7 are accepted); to prepare a target AP MLD only if MSCS is accepted by the target AP MLD; or to prepare a target AP MLD only if some other criteria for resource reservation is accepted. In one embodiment, if the STA 106 specifies multiple of these criteria, then each of the criteria has to be met by the target AP MLD for successful roaming preparation. In one embodiment, at least a certain number of these criteria have to be met at the target AP MLD for successful roaming preparation. In one embodiment, if multiple criteria are indicated in the preparation request frames 108-1 through 108-3, the STA 106 may indicate a preference order for these criteria. Then, the target AP MLD takes into account the preference order for the STA 106 when considering these criteria for roaming preparation. In one embodiment, the STA 106 may indicate in the preparation request frame 108-1 through 108-3 criteria for each of the multiple target AP MLDs. One or more fields can be signaled in the roaming preparation request frames 108-1 through 108-3 to signal these criteria. For example, these fields can be signaled in the SMD BSS Transition Parameters element in the ST Info field.

Each of the AP MLDs 104-1 through 104-6 may include a policy for roaming preparation. For example, the serving AP MLD 104-1 may include a policy for not preparing a target AP MLD for a STA when the target AP MLD meets or exceeds a threshold number of associated STAs or a threshold load. When the serving AP MLD 104-1 receives the roaming preparation request frames 108-1 through 108-3, the serving AP MLD 104-1 determines whether to transmit a request for roaming preparation to each of the target AP MLDs 104-3 through 104-5 based on the policy of the serving AP MLD 104-1, the preferences indicated in the roaming preparation request frames 108-1 through 108-3, and any policies on the respective target AP MLDs 104-3 through 104-5. If there is a conflict between the policy of the serving AP MLD 104-1, the preferences indicated in the roaming preparation request frames 108-1 through 108-3, or the policies on the respective target AP MLDs 104-3 through 104-5, then the serving AP MLD 104-1 may not proceed with preparing the respective target AP MLD 104-3 through 104-5. If there are no conflicts, then the serving AP MLD 104-1 transmits requests 110-1 through 110-3 for roaming preparation to the target AP MLDs 104-3 through 104-5, respectively. The target AP MLD 104-3 transmits a roam response 112-1 to the request 110-1 for roaming preparation. The target AP MLD 104-4 transmits a roam response 112-2 to the request 110-2 for roaming preparation. The target AP MLD 104-5 transmits a roam response 112-3 to the request roam 110-3 for roaming preparation. Each of the roam responses 112-1 through 112-3 indicates whether the respective target AP MLD 104-3 through 104-5 accepts or denies the respective request 110-1 through 110-3 for roaming preparation. If the request 110-1 through 110-3 for roaming preparation is accepted, then the respective target AP MLD 104-3 through 104-5 may transmit roaming preparation related information in the respective roam response 112-1 through 112-3.

When the serving AP MLD 104-1 receives the roam responses 112-1 through 112-3, the serving AP MLD 104-1 checks for any conflicts between the policy of the serving AP MLD 104-1, the preferences indicated in the roaming preparation request frames 108-1 through 108-3, or the policies on the respective target AP MLDs 104-3 through 104-5. If there are conflicts between the roam responses 112-1 through 112-3 and the policy of the serving AP MLD 104-1, the preferences indicated in the roaming preparation request frames 108-1 through 108-3, or the policies on the respective target AP MLDs 104-3 through104-5, then the serving AP MLD 104-1 may not transmit an accept response to the STA 106. For example, if the STA 106 indicated a preference for preparing an AP MLD only if all of the links in the roaming preparation request frame 108-1 are accepted and the target AP MLD 104-3 accepts a portion of the links, then the serving AP MLD 104-1 may transmit a response to the STA 106 indicating target AP MLD 104-3 did not accept because the target AP MLD 104-3 did not accept all of the requested links. If there are no conflicts, then the serving AP MLD 104-1 transmits the roaming preparation response frames 114-1 through 114-3 to indicate outcome and status of roaming preparation at target AP MLDs. In one embodiment, the serving AP MLD 104-1 transmits a roaming preparation response frame for each roaming preparation request frames. In one embodiment, the STA 106 transmits the roaming preparation request frames 108-1 through 108-3 in parallel. In another embodiment, the STA 106 transmits the roaming preparation request frames 108-1 through 108-3 in sequence and may wait to receive response 114-1 for the request 108-1, before transmitting second roaming preparation request 108-2.

If the STA 106 moves towards the target AP MLD 104-3, then, as depicted in FIG. 1B, the STA 106 performs roaming execution to the target AP MLD 104-3 based on the previous roaming preparation setup in FIG. 1A. If the STA 106 moves towards the target AP MLD 104-4, then, as depicted in FIG. 1C, the STA 106 performs roaming execution with the target AP MLD 104-4 based on the previous roaming preparation setup in FIG. 1A. By preparing for the STA 106 to roam to any of the target AP MLDs 104-3 through 104-5, the STA 106 can seamlessly transition from the serving AP MLD 104-1 to any one of the target AP MLDs 104-3 through 104-5.

Similar to the structure in FIGS. 1A, 1D depicts an SMD 150 that includes AP MLDs 154-1 through 154-6 to access a network. The AP MLDs 154-1 through 154-6 are part of the same SMD 150. Each of the AP MLDs 154-1 through 154-6 are deployed in different locations 152-1 through 152-4 in a given deployment (such as in a warehouse or an office building or an urban downtown area). A STA 156 (such as an AGV, AMR, a vehicle, a smartphone, a laptop, or a tablet) may be associated with an SMD-ME 168 in the SMD 150 and connected with one of the AP MLDs 154-1 through 154-6 to connect to the network. In an exemplary embodiment, the STA 156 is connected with the AP 154-1 because the AP MLD 154-1 is close to the STA 156, making the AP MLD 154-1 a serving AP MLD for the STA 156. The AP MLDs 154-1 through 154-6 function similar to the AP MLDs 104-1 through 104-6 depicted in FIG. 1A.

Unlike FIG. 1A, the STA 156 transmits one roaming preparation request frame 158 (e.g., a UHR link reconfiguration request frame) instead of the roaming preparation request frames 108-1 through 108-3. The roaming preparation request frame 158 may include an indication to prepare multiple target AP MLDs for roaming, such as the AP MLDs 154-3 through 154-5. In one embodiment, the number of target AP MLDs indicated in the roaming preparation request frame 158 is based on the maximum number of target AP MLDs indicated from the serving AP MLD 154-1(such as in a beacon, probe response, etc.). For example, if the AP MLD 154-1 indicates to the STA 156 that the maximum number of target AP MLDs allowed for roaming preparation is three, such as through a beacon, a probe response or a (re)association response, then the STA 156 may transmit a roaming preparation request frame indicating to prepare roaming to three or less target AP MLDs. The roaming preparation request frame 158 includes multiple reconfiguration ML elements, where each element corresponds to a different one of the AP MLDs 154-2 through 154-6. In an exemplary embodiment, the roaming preparation request frame 158 includes reconfiguration ML elements for the target AP MLDs 154-3 through 154-5.

In one embodiment, one of the multiple reconfiguration ML elements in the roaming preparation request frame 158 includes information for roaming preparation for one target AP MLD such as links to be added at the target AP MLD, the STA 156 context information (e.g. for SCS, Block acknowledge, etc.), and request for resource reservation at the target AP MLD. The STA 156 may use inheritance (similar to the inheritance defined for 802.11be) to inherit information from one of the multiple reconfiguration ML elements in the roaming preparation request frame 158 into other reconfiguration ML elements to fill in missing information. By using inheritance, the roaming preparation request frame 158 includes parameters and elements for the STA 156 once, which allows for a smaller, optimized message size. Each of the multiple reconfiguration ML elements in the roaming preparation request frame 158 may include a preference indicating the STA 156 preference to roam to one of the target AP MLDs 154-3 through 154-5 that is indicated in the roaming preparation request frame 158. The preference may be indicated in the reconfiguration ML elements as an identifier, such as, but not limited to, a number, letter, or a combination thereof.

In some embodiments, the STA 156 may prefer to prepare a target AP MLD that only accepts all links in each of the reconfiguration ML elements. The STA 156 can indicate a preference field of the roaming preparation request frame 158 to prepare the target AP MLD only if the target AP MLD can accept all requested links. For example, the field may be a 1-bit field that indicates “Prepare Only If All Requested Links Accepted.” If such an indication is provided in the roaming preparation request frame 158 from the STA 156 and one of the target AP MLDs 154-3 through 154-5 cannot accept all the requested links, then that target AP MLD is not prepared, and roaming preparation fails for that target AP MLD. An appropriate response (or status code) may be provided in a roaming preparation response frame 164 to indicate the reason for roaming preparation failure status code. The roaming preparation request frame 158 may include one or more of the following criteria for preparing a target AP MLD: to prepare a target AP MLD only if at least a minimum number of links are accepted by the target AP MLD (e.g., if requesting four links, then indicate to only prepare if at least 3 links are accepted); to prepare a target AP MLD only if a specific set of the requested links are accepted by the target AP MLD (e.g. if the STA 156 is requesting three links on 2.4 GHz, 5 GHz, and 6 GHz, then the STA 156 can indicate to only prepare if at least the 5 GHz and 6 GHz links are accepted); to prepare a target AP MLD only if at least a minimum number of SCS streams are accepted by the target AP MLD (e.g. if five SCS streams are set up, then the STA 156 may indicate to only prepare, if at least three SCS streams are accepted); to prepare a target AP MLD only if specific SCS streams or types of SCS streams (e.g. SCS streams with high priority traffic identifiers (TIDs)) are accepted by the target AP MLD (e.g. prepare only if SCS streams with TID 4, 5, 6, 7 are accepted or SCS streams with TIDs 6, 7 are accepted); to prepare a target AP MLD only if MSCS is accepted by the target AP MLD; or to prepare a target AP MLD only if some other criteria for resource reservation is accepted. In one embodiment, if the STA 156 specifies multiple of these criteria, then each of the criteria has to be met by the target AP MLD for successful roaming preparation. In one embodiment, at least a certain number of these criteria have to be met at the target AP MLD for successful roaming preparation. In one embodiment, if multiple criteria are indicated in the roaming preparation request frame 158, the STA 156 may indicate a preference order for these criteria. Then, the target AP MLD takes into account preference order for the STA 156 when considering these criteria for roaming preparation. In one embodiment, the STA 156 may indicate in the roaming preparation request frame 158 criteria for each of the multiple target AP MLDs.

Each of the AP MLDs 154-1 through 154-6 may include a policy for roaming preparation. For example, the serving AP MLD 154-1 may include a policy for not preparing a target AP MLD for a STA when the target AP MLD meets or exceeds a threshold number of associated STAs or a threshold load. When the serving AP MLD 154-1 receives the roaming preparation request frame 158, the serving AP MLD 154-1 determines whether to transmit a request to each of the target AP MLDs 154-3 through 154-5 for roaming preparation based on the policy of the serving AP MLD 154-1, the preferences indicated in the roaming preparation request frame 158, and any policies on the respective target AP MLDs 154-3 through 154-5. If there is a conflict between the policy of the serving AP MLD 154-1, the preferences indicated in the roaming preparation request frame 158, or the policies on the respective target AP MLDs 154-3 through 154-5, then the serving AP MLD 154-1 may not proceed with preparing the respective target AP MLD 154-3 through 154-5. If there are no conflicts, then the serving AP MLD 154-1 transmits requests 160-1 through 160-3 for roaming preparation to the target AP MLDs 154-3 through 154-5, respectively. The target AP MLD 154-3 transmits a response 162-1 to the request 160-1 for roaming preparation. The target AP MLD 154-4 transmits a response 162-2 to the request 160-2 for roaming preparation. The target AP MLD 154-5 transmits a response 162-3 to the request 160-3 for roaming preparation. Each of the requests 160-1 through 160-3 for roaming preparation indicates whether the respective target AP MLD 154-3 through 154-5 accepts or denies the respective request 160-1 through 160-3 for roaming preparation. If the request 160-1 through 160-3 for roaming preparation is accepted, then the respective target AP MLD 154-3 through 154-5 may transmit roaming information in the respective response 162-1 through 162-3.

When the serving AP MLD 154-1 receives the responses 162-1 through 162-3, the serving AP MLD 154-1 transmits a roaming preparation response frame 164 that includes each of the response 162-1 through 162-3. In one embodiment, similar to the serving AP MLD 104-1 depicted in FIG. 1A, the serving AP MLD 154-1 transmits a number of roaming preparation response frames to the STA 156 equal to the number of target AP MLDs indicated in the roaming preparation request frame 158. In one embodiment, the serving AP MLD 154-1 prepares for the STA 156 to roam to each of the AP MLDs 154-3 through 154-5 sequentially.

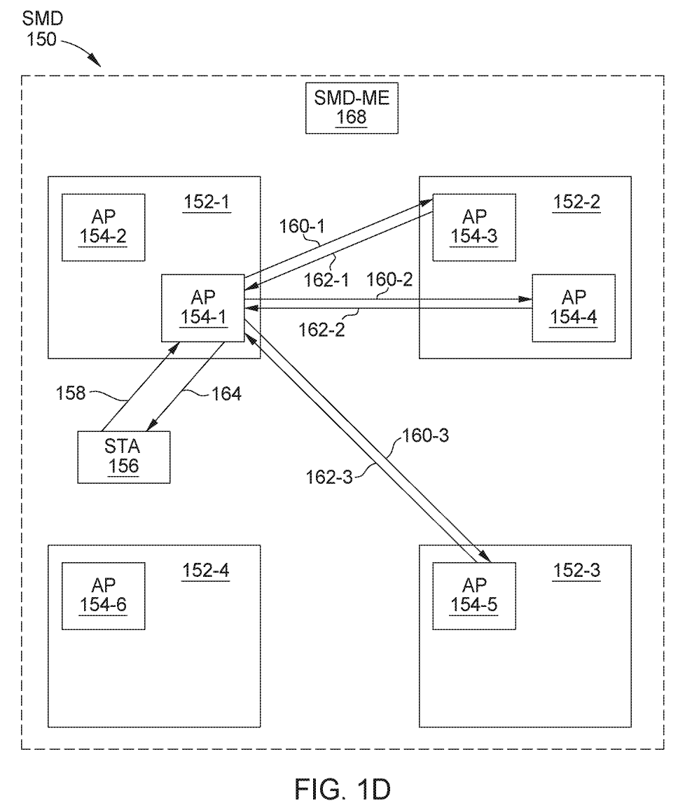

FIG. 2 depicts a flowchart of an exemplary method 200 for preparing multiple AP MLDs (such as the AP MLDs 104-1 through 104-6 depicted in FIG. 1A) for a STA (such as the STA 106 depicted in FIG. 1A) to roam. The STA may access a network by associating with a SMD-ME (such as the SMD-ME 118 depicted in FIG. 1A) in a SMD (such as the SMD 100 depicted in FIG. 1A) and connecting to one of the multiple AP MLDs on the network, making the AP MLD a serving AP MLD. As the STA moves, the STA may move away from the serving AP MLD causing the STA to disconnect from the network. To help prevent the STA from disconnecting from the network, the serving AP MLD may prepare target AP MLDs for roaming. The serving AP MLD can inform the STA of this capability by, at block 202, transmitting a beacon to the STA indicating a maximum number of target AP MLDs for roaming. By transmitting the beacon to the STA, the STA is informed that the serving AP MLD can prepare multiple target AP MLDs for roaming and the STA is informed of the maximum number of target AP MLDs that the STA can indicate in a roaming preparation request.

The serving AP MLD, at block 204, receives multiple roaming preparation request frames (such as the roaming preparation request frames 108-1 through 108-3 depicted in FIG. 1A) from the STA. Each of the multiple roaming preparation request frames indicates a different one of the multiple target AP MLDs for roaming preparation. In one embodiment, the number of the multiple roaming preparation request frames does not exceed the maximum number of target AP MLDs. In one embodiment, the multiple roaming preparation request frames indicate a preference order for roaming to the multiple target AP MLDs.

At block 206, the serving AP MLD transmits requests for roaming preparation (such as the requests 110-1 through 110-3 depicted in FIG. 1A) to the multiple target AP MLDs. In one embodiment, the serving AP MLD receives information from target AP MLDs indicating the loads on the respective target AP MLD and the number of associated STAs on the respective target AP MLD. The serving AP MLD may include a policy that indicates to not send a request for roaming preparation to a target AP MLD that meets or exceeds a load threshold or a threshold number of associated STAs. For example, if the serving AP MLD receives a frame from a target AP MLD indicating the target AP MLD has five associated STAs and the serving AP MLD has a policy to not send requests for roaming preparation to target AP MLDs with five or more associated STAs, the serving AP MLD may not send the request for roaming preparation from the STA to the target AP MLD. As such, the number of requests for roaming preparation sent from the serving AP MLD may be less than the number of roaming preparation request frames from the STA.

At block 208, the serving AP MLD receives multiple responses (such as the responses 112-1 through 112-3 depicted in FIG. 1A) to the request for roaming preparation. Each of the multiple responses indicates whether a different one of the multiple target AP MLDs accepts or denies the request for roaming preparation. If one of the multiple target AP MLDs accepts the request for roaming preparation, the respective response may contain roaming preparation related information to be transmitted to the STA. In one embodiment, the serving AP MLD maintains the information for roaming in memory in the serving AP MLD (e.g., the list of target AP MLDs that have been prepared for the STA).

At block 210, the serving AP MLD transmits multiple roaming preparation response frames (such as the roaming preparation response frames 114-1 through 114-3 depicted in FIG. 1A) to the STA. For each of the multiple roaming preparation request frames from the STA, the serving AP MLD transmits a respective roaming preparation response frame indicating whether the respective one of the multiple target AP MLDs accepted or denied the request for roaming preparation. If one of the multiple target AP MLDs accepted the request for roaming preparation, the roaming preparation response frame may include information for roaming to the respective target AP MLD. In one embodiment, if the serving AP MLD elected not to send a request for roaming preparation to one of the target AP MLDs (such as due to the target AP MLD having a number of associated STA exceeding a threshold number), the serving AP MLD may transmit a deny response to the STA for the respective target AP MLD. When the STA roams from the serving AP MLD, the serving AP MLD may remove the roaming information from memory in the serving AP MLD.

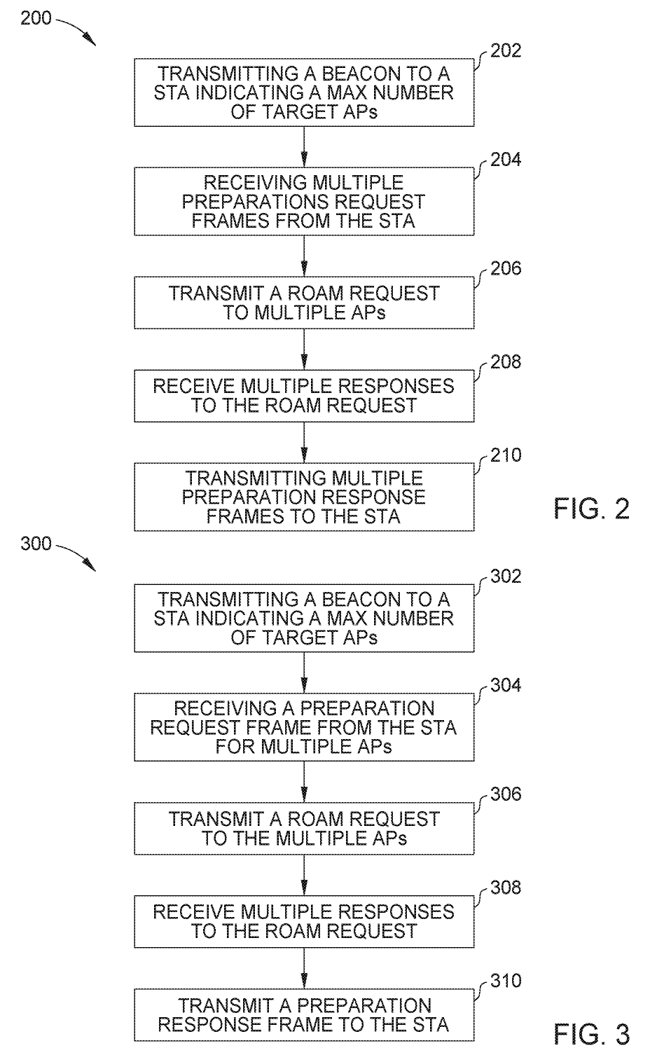

FIG. 3 depicts a flowchart of an exemplary method 300 for preparing multiple AP MLDs (such as the AP MLDs 154-1 through 154-6 depicted in FIG. 1D) for a STA (such as the STA 156 depicted in FIG. 1D) to roam. Similar to the exemplary method 200, the STA may access a network by associating with a SMD-ME (such as the SMD-ME 168 depicted in FIG. 1D) in a SMD (such as the SMD 150 depicted in FIG. 1A) and connecting to one of the multiple AP MLDs on the network, making the AP MLD a serving AP MLD. As the STA moves, the STA may move away from the serving AP MLD causing the STA to disconnect from the network. To help prevent the STA from disconnecting from the network, the serving AP MLD may prepare target AP MLDs for roaming. The serving AP MLD can inform the STA of this capability by, at block 302, transmitting a beacon to the STA indicating a maximum number of target AP MLDs for roaming. By transmitting the beacon to the STA, the STA is informed that the serving AP MLD can prepare multiple target AP MLDs for roaming and the STA is informed of the maximum number of target AP MLDs that the STA can indicate in a roaming preparation request.

Unlike block 204 described in FIG. 2, the serving AP MLD, at block 304, receives a roaming preparation request frame (such as the roaming preparation request frame 158 depicted in FIG. 1D) from the STA. Instead of multiple roaming preparation request frames, the roaming preparation request frame may indicate multiple different target AP MLDs that the STA wants to prepare for roaming. In one embodiment, the number of the different target AP MLDs in the roaming preparation request frame does not exceed the maximum number of target AP MLDs. In one embodiment, the roaming preparation request frame indicates a preference order for roaming to the multiple target AP MLDs. In one embodiment, one element in the roaming preparation request frame includes more information than other elements in the roaming preparation request frame. By including more information in one element of the roaming preparation request frame, the STA can apply inheritance across information indicated for each of the multiple target AP MLDs.

At block 306, the serving AP MLD transmits requests for roaming preparation (such as the requests 160-1 through 160-3 depicted in FIG. 1D) to the multiple target AP MLDs. In one embodiment, the serving AP MLD receives information from target AP MLDs indicating the loads on the respective target AP MLD and the number of associated STAs on the respective target AP MLD. The serving AP MLD may include a policy that indicates to not send a request for roaming preparation to a target AP MLD that meets or exceeds a load threshold or a threshold number of serving AP MLDs. For example, if the serving AP MLD receives a frame from a target AP MLD indicating the target AP MLD has five associated STAs and the serving AP MLD has a policy to not send requests for roaming preparation to target AP MLDs with five or more associated STAs, the serving AP MLD may not send the request for roaming preparation from the STA to the target AP MLD. As such, the number of requests for roaming preparation sent from the serving AP MLD may be less than the number of target AP MLDs indicated in the roaming preparation request frame from the STA.

At block 308, the serving AP MLD receives multiple responses (such as the responses 162-1 through 162-3 depicted in FIG. 1D) to the request for roaming preparation. Each of the multiple responses indicates whether a different one of the multiple AP MLDs accepts or denies the request for roaming preparation. If one of the multiple target AP MLDs accepts the request for roaming preparation, the respective response may contain information for roaming to be transmitted to the STA. In one embodiment, the serving AP MLD maintains the information for roaming in memory in the serving AP MLD (e.g., the list of target AP MLDs that have been prepared for the STA).

At block 310, the serving AP MLD transmits a roaming preparation response frame (such as the roaming preparation response frame 164 depicted in FIG. 1D) to the STA. The roaming preparation response frame may include a combination of each of the multiple responses to the requests for roaming preparation indicating whether the respective one of the multiple target AP MLDs accepted or denied the request for roaming preparation. If one of the multiple target AP MLDs accepted the request for roaming preparation, the roaming preparation response frame may include information for roaming to the respective target AP MLD. In one embodiment, if the serving AP MLD elected not to send a request for roaming preparation to one of the target AP MLDs (such as due to the target AP MLD having a number of associated STA exceeding a threshold number), the serving AP MLD may transmit a deny response to the STA for the respective target AP MLD. In one embodiment, similar to block 210 described in FIG. 2, the serving AP MLD transmits a separate roaming preparation response frame to the STA for each of the responses to the request for roaming preparation. When the STA roams from the serving AP MLD, the serving AP MLD may remove the roaming information from memory in the serving AP MLD.

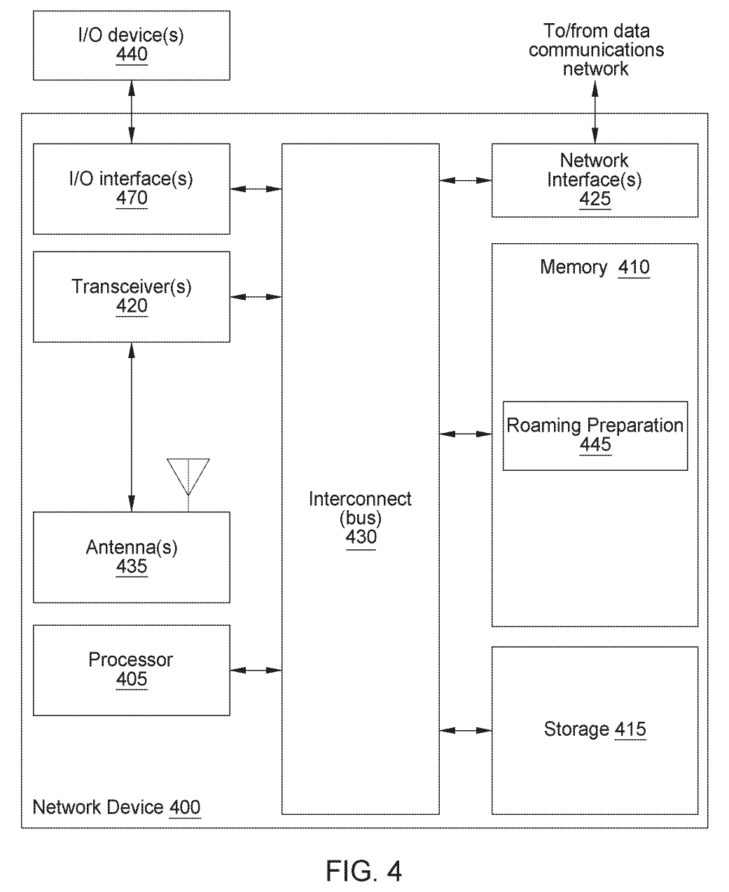

FIG. 4 depicts an example network device 400 configured to perform various aspects of the present disclosure, according to some aspects of the present disclosure. The network device 400 may be an AP MLD, which corresponds to the AP MLDs 104-1 through 104-6 depicted in FIG. 1A.

As illustrated, the example network device 400 includes a processor 405, memory 410, storage 415, one or more transceivers 420, one or more input/output (I/O) interfaces 470, and one or more network interfaces 425. In some embodiments, I/O devices 440 are connected via the I/O interface(s) 470. Further, via the network interface 425, the network device 400 can be communicatively coupled with one or more other devices and components (e.g., via a network, which may include the Internet, local network(s), and the like). Each of the components is communicatively coupled by one or more buses 430. In some embodiments, one or more antennas 435 may be coupled to the transceivers 420 for transmitting and receiving wireless signals.

The processor 405 is generally representative of a single CPU and/or graphic processing unit (GPU), an NPU, multiple CPUs and/or GPUs, a microcontroller, an application-specific integrated circuit (ASIC), or a programmable logic device (PLD), among others. The processor 405 processes information received through the transceiver 420, I/O interfaces 470, and the network interfaces 425. The processor 405 retrieves and executes programming instructions stored in memory 410, as well as stores and retrieves application data residing in storage 415.

The storage 415 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 415 may store a variety of data for the efficient functioning of the system.

The memory 410 may include random access memory (RAM) and read-only memory (ROM). The memory 410 may store processor-executable software code containing instructions that, when executed by the processor 405, enable the network device 400 to perform various functions described herein for wireless communication. In the illustrated example, the memory 410 includes a software component, roaming preparation 445.

In one embodiment, the roaming preparation 445 is configured to prepare a STA and target AP MLD for the STA to roam. As the network device 400 receives a request to prepare for roaming from the STA, the roaming preparation 445 transmits requests a subset of target AP MLDs to determine if the target AP MLDs will accept the STA roaming to the respective target AP MLD. The target AP MLD transmits a response back to the network device 400 and the roaming preparation 445 transmits the responses back to the STA. The responses may include information for roaming if the target AP MLD accepted the roaming request. The roaming preparation 445 may maintain the information for roaming on the network device 400 until the STA roams from the network device 400 to one of the target AP MLD.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point multi-link device (AP MLD) comprising:
one or more memories; and
one or more processors communicatively coupled to the one or more memories, wherein the one or more processors are configured to, individually or collectively, perform operations comprising:
receiving a roaming preparation request from a station (STA);
transmitting, based on the roaming preparation request, a second request to a plurality of target AP MLDs;
receiving a plurality of responses to the second request from the plurality of target AP MLDs, wherein each of the plurality of responses indicates whether a respective target AP MLD in the plurality of target AP MLDs accepts the second request; and
transmitting, based on the plurality of responses, a roaming preparation response to the STA, wherein the roaming preparation response comprises information for the STA to roam to at least one of the plurality of target AP MLDs.

2. The AP MLD of claim 1, wherein the roaming preparation request comprises a plurality of request frames, wherein each of the second requests are designated for a different target AP MLD for roaming, wherein the roaming preparation response comprises a plurality of response frames, and wherein each of the plurality of response frames are for responses from each of the plurality of target AP MLDs.

3. The AP MLD of claim 2, wherein each of the second requests and each of the plurality of response frames comprises an identifier indicating each of the second requests and each of the plurality of response frames are based on the roaming preparation request from the STA.

4. The AP MLD of claim 3, wherein the operations further receiving an updated roaming preparation request indicating an updated element of the roaming preparation request, and wherein the updated roaming preparation request comprises the identifier indicating that the updated roaming preparation request is an update for the roaming preparation request instead of a new roaming preparation request.

5. The AP MLD of claim 1, wherein the AP MLD comprises a maximum number of target AP MLDs for roaming preparation, wherein the operations further comprise prior to receiving the roaming preparation request, transmitting a beacon frame to the STA indicating the maximum number of target AP MLDs and indicating that the AP MLD supports roaming preparation for a plurality of target AP MLDs, wherein the roaming preparation request indicates a number of target AP MLDs for the AP MLD to start roaming preparation, and wherein the number of target AP MLDs for the AP MLD to start roaming preparation equals the maximum number of target AP MLDs.

6. The AP MLD of claim 5, wherein transmitting the second requests to the plurality of target AP MLDs comprises the AP MLD transmitting the second request to a number of target AP MLDs that is less than the number of target AP MLDs due to at least one of the plurality of target AP MLDs having a load that meets or exceeds a first threshold number or one of the plurality of target AP MLDs having a number of associated STAs that meets or exceeds a second threshold.

7. The AP MLD of claim 1, wherein the roaming preparation request comprises a plurality of links from the STA for a target AP MLD to accept, wherein the roaming preparation request indicates a preference for roaming to a target AP MLD that accepts each of the plurality of links from the STA, and wherein the AP MLD establishes roaming preparation for the plurality of target AP MLDs that accepts each of the plurality of links and does not establish roaming preparation for the plurality of target AP MLDs that do not accept each of the plurality of links.

8. The AP MLD of claim 1, wherein the roaming preparation request comprises a preference field indicating to prepare of the plurality of target AP MLDs for roaming if the respective target AP MLD accepts at least one of the following criteria:
the target AP MLD accepts a minimum number of requested links;
the target AP MLD accepts a specific set of the requested links;
the target AP MLD accepts a minimum number of Stream Classification Service (SCS) streams;
the target AP MLD accepts specific SCS streams; or
the target AP MLD accepts Mirrored Stream Classification Service (MSCS).

9. The AP MLD of claim 8, wherein the respective target AP MLD has to accept each of the criteria for successful roaming preparation.

10. An access point multi-link device (AP MLD) comprising:
one or more memories; and
one or more processors communicatively coupled to the one or more memories, wherein the one or more processors are configured to, individually or collectively, perform operations comprising:
receiving a plurality of roaming preparation request frames from a station (STA), wherein each of the plurality of roaming preparation request frames designates a different target AP MLD in a plurality of target AP MLDs for roaming;
transmitting, based on the plurality of roaming preparation request frames, a second request to the plurality of target AP MLDs;
receiving a plurality of responses to the second request from the plurality of target AP MLDs, wherein each of the plurality of responses indicates whether a respective target AP MLD in the plurality of target AP MLDs accepts the second request; and
transmitting, based on the plurality of responses, a plurality of roaming preparation response frames to the STA, wherein the plurality of roaming preparation response frames comprises information for the STA to roam to at least one of the plurality of target AP MLDs, and wherein the number of the plurality of roaming preparation response frames matches the number of the plurality of roaming preparation request frames.

11. The AP MLD of claim 10, wherein each of the second requests are designated for a different target AP MLD of the plurality of target AP MLDs, and wherein each of the plurality of responses are for responses from each of the plurality of target AP MLDs.

12. The AP MLD of claim 11, wherein each of the second requests and each of the plurality of responses comprises an identifier indicating each of the second requests and each of the plurality of responses are based on one of the plurality of roaming preparation request frames from the STA.

13. The AP MLD of claim 12, wherein the operations further receiving an updated roaming preparation request indicating an updated element of at least one of the plurality of roaming preparation request frames, and wherein the updated roaming preparation request comprises the identifier indicating that the updated roaming preparation request is an update for at least one of the plurality of roaming preparation request frames instead of a new roaming preparation request.

14. The AP MLD of claim 10, wherein the AP MLD comprises a maximum number of target AP MLDs for roaming preparation, wherein the operations further comprise prior to receiving the roaming preparation request, transmitting a beacon frame to the STA indicating the maximum number of target AP MLDs and indicating that the AP MLD supports roaming preparation for a plurality of target AP MLDs, wherein the roaming preparation request indicates a number of target AP MLDs for the AP MLD to start roaming preparation, and wherein the number of target AP MLDs for the AP MLD to start roaming preparation equals the maximum number of target AP MLDs.

15. The AP MLD of claim 10, wherein the plurality of roaming preparation request frames comprises a preference field indicating to prepare of the plurality of target AP MLDs for roaming if the respective target AP MLD accepts at least one of the following criteria:
the target AP MLD accepts a minimum number of requested links;
the target AP MLD accepts a specific set of the requested links;
the target AP MLD accepts a minimum number of Stream Classification Service (SCS) streams;
the target AP MLD accepts specific SCS streams; or
the target AP MLD accepts Mirrored Stream Classification Service (MSCS).

16. A method comprising:
receiving, on an access point multi-link device (AP MLD), a roaming preparation request from a station (STA);
transmitting, from the AP MLD, based on the roaming preparation request, a second request to a plurality of target AP MLDs;
receiving, on the AP MLD, a plurality of responses from the plurality of target AP MLDs based on the second requests, wherein each of the plurality of responses indicates whether a respective target AP MLD in the plurality of target AP MLDs accepts the second request; and
transmitting, from the AP MLD, based on the plurality of responses, a roaming preparation response to the STA, wherein the roaming preparation response comprises information for the STA to roam to at least one of the plurality of target AP MLDs.

17. The method of claim 16, wherein each of the second requests are designated for a different target AP MLD of the plurality of target AP MLDs, and wherein each of the plurality of roaming preparation response are for responses from each of the plurality of target AP MLDs.

18. The method of claim 17, wherein each of the second requests and each of the plurality of response comprises an identifier indicating each of the second requests and each of the plurality of response are based on the roaming preparation request from the STA.

19. The method of claim 16, wherein the AP MLD comprises a maximum number of target AP MLDs for roaming preparation, wherein the method further comprises prior to receiving the roaming preparation request, transmitting a beacon frame to the STA indicating the maximum number of target AP MLDs and indicating that the AP MLD supports roaming preparation for a plurality of target AP MLDs, wherein the roaming preparation request indicates a number of target AP MLDs for the AP MLD to start roaming preparation, and wherein the number of target AP MLDs for the AP MLD to start roaming preparation equals the maximum number of target AP MLDs.

20. The method of claim 16, wherein the roaming preparation request comprises a preference field indicating to prepare of the plurality of target AP MLDs for roaming if the respective target AP MLD accepts at least one of the following criteria:
the target AP MLD accepts a minimum number of requested links;
the target AP MLD accepts a specific set of the requested links;
the target AP MLD accepts a minimum number of Stream Classification Service (SCS) streams;
the target AP MLD accepts specific SCS streams; or
the target AP MLD accepts Mirrored Stream Classification Service (MSCS).
